(19) United States
(12) Patent Application Publication
(10) Pub. No.: US 2023/0228040 A1
(43) Pub. Date: Jul. 20, 2023

(54) MOLDING DEVICES AND METHODS FOR MAKING ELASTOMERIC PADS FOR USE AS RAIL TIES

(71) Applicant: Dow Global Technologies LLC, Midland, MI (US)

(72) Inventors: Yinglong Chen, Lake Jackson, TX (US); Larry Dotson, Midland, MI (US); Huang Wu, Sugar Land, TX (US); Jason A. Reese, Auburn, MI (US); Kevin W. Light, Marietta, GA (US); Larry W. Mobley, Canton, GA (US); Maria Jose Cotanda Santapau, Lake Jackson, TX (US)

(21) Appl. No.: 18/002,212

(22) PCT Filed: Aug. 30, 2021
(86) PCT No.: PCT/US2021/048170

§ 371 Date: Dec. 16, 2022

Related U.S. Application Data
(60) Provisional application No. 63/072,987, filed on Sep. 1, 2020.

(51) Int. Cl. E01B 3/46; B29C 44/34; B29C 44/12

(52) U.S. Cl. CPC E01B 3/46; B29C 44/351; B29C 44/1271; B29K 2105/041

(57) ABSTRACT

The present invention provides multi-layer articles for use as a rail tie footings comprising, as the tie, an elongate rigid body having a substantially planar surface, and on the substantially planar surface comprising a a microcellular foam elastomeric pad, for example, of a substantially organic solvent free polyurethane, wherein the substantially planar surface has a peripheral landing on which there is no elastomeric pad and the elastomeric pad has a bulk density (ASTM D3676) of from 600 to 2000 Kg/m3 (0.6 to 2.0 g/cm3). In addition, the present invention provides molding methods wherein the microcellular foam elastomeric pad is molded directly on the rail tie to form a durable footing, wherein the rail tie forms the bottom boundary of a molding chamber during molding and molding comprises forming the top and side boundaries of the molding chamber by inflating an annular pneumatic seal, positioning the seal on the substantially planar surface of the elongate rigid body and keeping the microcellular foam forming materials under pressure during molding.

### FIELD OF THE INVENTION

The present invention relates to molding methods for producing durable multi-layer articles having a resilient shock-absorbing or noise or vibration damping footing or pad and useful as rail ties, molding devices therefor, and the articles produced by the molding methods. In particular, it relates to rail ties having as a footing an elastomeric pad comprising a microcellular foam formed from a substantially organic solvent free composition, preferably, a polyurethane. In another aspect, the present invention relates to a molding device comprising a molding chamber defined at its periphery by an annular pneumatic seal, a heated surface defining the upper side of the molding chamber, wherein the molding device sits on top of the underside of the rail tie and the underside of the rail tie defines the bottom boundary of the molding chamber of the molding device. In yet another aspect, the present invention, in particular, relates to molding methods comprising inflating the annular pneumatic seal to form a seal disposed around and defining a circumferential side wall or side boundary of a molding chamber bounded at the top by a molding device and on the bottom by the underside surface of the tie, followed by injection molding the elastomeric pad in the molding chamber to form the elastomeric pad directly onto the underside surface of the tie.

### BACKGROUND OF THE INVENTION

Known methods of forming rail ties having padded feet a foam layer pad can be directly sprayed onto the rail ties, such as by manual spraying. However, such a method is labor intensive, often interfering with the rail tie production line. Further, the manual spray on site suffers from inconsistent thickness of the pad and related quality issues. Accordingly, more recent commercial pads for use as under tie footings comprise premade pads/mats of an elastomeric layer or its composites. Such composites may include a layer of nonwoven/woven fabric. Further, the pads may be adhered to the rail tie by use of an adhesive.

Still further, to prevent interference with a rail tie production line, methods of forming pads for rail ties may comprise embedding the pad material into the concrete using a layer of fabric comprising part of the pad while tie itself cures. For example, preformed pads are vibrated into wet concrete. However, the operation window of such a method is limited by the rate that the concrete hardens. So, either the curing rate of the concrete is limited to facilitate pad installation or the installation process has to be rushed, resulting in a high rejection rate.

Recently, World Intellectual Property Organization (WIPO) publication WO2008101269A1, to Schwellenwerk Und Steuerun, has disclosed a method for producing a rail tie (sleeper) pad (footing) formed from a plastic foam, wherein the raw material for the plastic foam is applied to the at least one surface of the sleeper and then foamed in situ onto the surface of the sleeper form the plastic foam. According to the Schwellenwerk disclosure, the foam may be applied freeform or in a mold, such as a mold with a press. Thus, the Schwellenwerk disclosure recognizes no advantage of or disadvantage of molding; and the disclosure fails to demonstrate improved adhesion of the pad to the rail tie.

The present inventors have endeavored to solve the problem of providing methods for consistently making rail ties having as a footing a resilient elastomeric pad which adheres consistently to the rail tie in use.

### SUMMARY OF THE INVENTION

In accordance with the present invention, a multi-layer article for use as a rail tie comprises an elongate rigid body having a substantially planar surface and a microcellular foam elastomeric pad on the substantially planar surface comprising a microcellular foam, preferably, of a polyurethane, or more, preferably, of a substantially organic solvent free polyurethane composition, wherein the substantially planar surface has a peripheral landing on which there is no elastomeric pad. The elastomeric pad has a bulk density (ASTM D3676) of from 600 to 2000 Kg/m³ (0.6 to 2.0 g/cm³), or, preferably, from 700 to 1800 Kg/m³ (0.7 to 1.8 g/cm³). More preferably, the microcellular polyurethane foam comprises cells formed from water as a blowing agent. Preferably, the microcellular foam has a core and an outer periphery having a skin around its outer periphery characterized by having a greater density in its skin than in its core. The multi-layer article for use as a rail tie may be one comprising an elongate rigid body having a length and a width, and a substantially planar surface extending the entire length and width of the elongate rigid body adapted for use as a foot on which the elongate rigid body rests; and, an elastomeric pad on the substantially planar surface comprising a microcellular foam of a polyurethane, preferably, a substantially organic solvent free composition, wherein, in the multi-layer article, the substantially planar surface has a peripheral landing on which there is no elastomeric pad. In addition, the elongate rigid body may comprise a porous material, preferably, concrete, fiber reinforced cement, or wood, and the microcellular foam extends into the pores of the elongate rigid body. The multi-layer article may further comprise a polyurea or polyurethane urea layer between the substantially planar surface of the elongate rigid body and the microcellular foam elastomeric pad.

In another aspect in accordance with the present invention, molding methods comprise inflating an annular pneumatic seal, such as a rubber seal, having an inner side and, adjacent the inner side, a top side and a bottom side having a width, contained in a molding device equipped with a molding chamber having a top boundary and a side boundary, the molding device having an upper structure that forms the top boundary of the molding chamber and abuts against the top side of the annular pneumatic seal to form the side boundary of the molding chamber, and an injection port extending through the upper structure into the molding chamber, thereby forming a circumferential annular seal against the top boundary of the molding chamber, positioning the molding device so that the bottom side of the annular pneumatic seal abuts sealingly against a substantially planar surface of an elongate rigid body, preferably, a porous surface, at an outer periphery of the substantially planar surface to form a bottom boundary of the molding chamber, molding by mixing, and then injecting a two-component foam forming mixture, preferably, a substantially organic solvent free two-component foam forming mixture into the molding chamber and curing it in the molding chamber to form an elastomeric pad directly on the substantially planar surface of the elongate rigid body. In the methods, the substantially planar surface has a shape, length and a width, and the shape, length and width of each of the substantially planar surface and of the top boundary of the molding chamber are congruent or are the same. At least 50%, or, preferably, more than 50%, such as more than 55% or, preferably from more than 50 to 90% of the width of the bottom side of the annular pneumatic seal forms a seal with the substantially planar surface at its outer periphery. The area sealed by the bottom side of the annular pneumatic seal against the substantially planar surface forms a peripheral landing on the substantially planar surface of the elongate rigid body. In the methods in accordance with the present invention, molding comprises keeping the two-component foam forming mixture and the substantially planar surface under pressure during molding.

Preferably, in accordance with the methods of the present invention, the two-component foam forming mixture is a substantially solvent free polyurethane forming mixture of a polyol component and an isocyanate component, further comprising water as a blowing agent.

In accordance with the molding methods of the present invention, the mold plate of the molding device is heated and the methods further comprise heating the top surface of the mold plate before and during injection molding.

In accordance with the molding methods of the present invention, the mold plate of the molding device may further comprise one or more clamps to fasten the substantially planar surface of the elongate rigid body against the bottom side of the annular pneumatic seal.

In accordance with the methods of the present invention, the elongate rigid body is suitable for use as a rail tie.

In yet another aspect in accordance with the present invention, a molding device comprises a molding chamber having a top and side boundaries and adapted to receive a moldable material, the molding chamber bound on top by a surface, such as a mold plate, and on its sides by an inflatable annular pneumatic seal which forms an annular seal disposed around the molding chamber and forming its side boundary, the molding device further comprising an injection port, and frame assembly for attachment of the mold plate, the annular pneumatic seal and the injection port, wherein the molding device rests on top of a substantially planar surface of an elongate rigid body and forms a seal with an outer periphery of the substantially planar surface so that the substantially planar surface on the elongate rigid body defines the bottom boundary of the molding chamber. In the molding device, the substantially planar surface and the mold plate are congruent, have the same shape and extend for the same length and width. The mold plate is heated, for example by use of a heating pad. Accordingly, the molding device may further comprise a heated molding liner or heating pad positioned to heat the mold plate, for example, above the mold plate or opposite the side of the mold plate that forms the top boundary of the molding chamber, and, further, may comprise an insulator board which protects the outside of the molding device from the heater pad.

### BRIEF DESCRIPTION OF THE DRAWINGS

FIG. 1 depicts an example of the top, sides and one end of a suitable molding device useful for forming an elastomeric pad on a single rail tie in accordance with the present invention.

FIG. 2 depicts an sectional view showing the features of a suitable molding device in accordance with the present invention.

FIG. 3 depicts the layers of a multi-layer article in accordance with the present invention and suitable as a rail tie having thereon an elastomeric pad.

### DETAILED DESCRIPTION OF THE INVENTION

In accordance with the present invention, methods to produce a uniform elastomeric pad for use as a pad for a rail tie comprise molding the pad directly on the bottom surface of the tie, such as by molding an elastomeric reaction mixture under pressure. Further, in accordance with the present invention, multi-layer articles comprise an elongate rigid body having a substantially planar surface, such as a cement, concrete or wood body suitable as a rail tie, having a microcellular foam elastomeric pad layer thereon. The elastomeric pad may be a polyurethane, preferably a two-component substantially solvent free polyurethane microcellular foam, such as one formed using water as a blowing agent. The elastomeric pad is useful as a foot on which the elongate rigid body rests and can comprise a core and an outer periphery wherein the outer periphery is denser than the core. In the multi-layer article, the elongate rigid body may have a peripheral landing on which there is no elastomeric pad. Still further, in accordance with the present invention, a molding device for forming the elastomeric pad on the elongate rigid body comprises a molding chamber bounded at the top by a mold plate, preferably, a heated mold plate, and on its sides by an annular pneumatic seal that defines an annular boundary disposed around and defining a circumferential side wall. When inflated, the annular pneumatic seal provides sealing pressure and enhances pressure on the molding material in process. The present invention provides rapid production rate of the microcellular foam elastomeric pads via in situ foaming, reduces leaks and other waste of the reaction mixture in processing and insures consistent quality control.

Unless otherwise indicated, conditions of temperature and pressure are ambient temperature, a relative humidity of 30%, and standard pressure (1 atm).

Unless otherwise indicated, any term containing parentheses refers, alternatively, to the whole term as if parentheses were present and the term without them, and combinations of each alternative. Thus, as used herein the term, “(poly)diol” and like terms is intended to include any diol, oligomer or polymer thereof.

All ranges are inclusive and combinable. For example, the term “at least 50%, or, preferably, more than 50%, such as more than 55%, or, from more than 50 to 90% of the width of the bottom side of the annular pneumatic seal” would include each of from 50 to 100% (at least 50%), or, preferably, from more than 50 to 100%, or, preferably, from 55 to 100%, or, from 50 to 90%, or, preferably, from more than 50 to 90%, or, preferably, from 55 to 90%, or, from 50 to more than 50%, or, from 50 to 55%, or, preferably, from more than 50 to 55%, or, preferably, from 90 to 100% of the width of the bottom side of the annular pneumatic seal. Further, when ranges are given, any endpoints of those ranges and/or numbers recited within those ranges can be combined within the scope of the present invention.

As used herein, the term “ASTM” refers to publications of ASTM International, West Conshohocken, Pa.

As used herein, the term “component” refers to a composition containing one or more ingredients which is combined with another component to start a reaction, polymerization, foam formation or cure. Components are kept separate until combined at the time of use or reaction.

As used herein, unless otherwise indicated, the term “isocyanate index” refers to the ratio of the number of equivalents of isocyanate functional groups to hydroxyl groups or active hydrogen groups in a given polyurethane forming reaction mixture, multiplied by 100 and expressed as a number. For example, in a reaction mixture wherein the number of equivalents of isocyanate equals the number of equivalents of active hydrogen, the isocyanate index is 100.

As used herein, the term “phr” means per hundred parts weight resin, as solids.

As used herein, the term “polyisocyanate” refers to an isocyanate group containing material having two or more isocyanate functional groups, such as a diisocyanate, or a biuret, allophanate, isocyanurate, carbodiimide, dimer, trimer or oligomer thereof made by reaction of an excess of isocyanate with one or more diols.

As used herein, the term “substantially planar surface” means a surface that is planar absent pores, indentations, holes or cracks, such as a planar porous surface having through holes.

As used herein, the term “substantially solvent free” means that a given composition contains no added solvent and that the composition actually has no more than 2000 ppm of solvent.

As used herein, the term “total solids” or “solids” refers to everything in a given composition other than volatile materials like water and volatile solvents which flash off or volatilize at below 40° C. and atmospheric pressure.

As used herein, the phrase “wt. %” stands for weight percent.

The microcellular polyurethane elastomer of the microcellular foam elastomeric pad in accordance with the present invention is formed by a two-component foam forming mixture comprising one or more blowing agents, such as a two-component polyurethane foam forming mixture having water as a blowing agent. The two-component foam forming mixture forms a close celled microcellular foam. Preferably, the two-component foam forming mixture is substantially organic solvent free. reacting one component of an organic polyisocyanate, such as an aromatic diisocyanate, biuret, isocyanurate or allophanate thereof, or a polyisocyanate prepolymer from a chain extender and an excess of moles of a polyisocyanate, with, as a polyol component, a polyether polyol having two or more functional groups, for example, an average number of functional groups of 2.0 to 3.5, and a number average molecular weight of from 1000 to 10,000, or, for example, from 2000 to 8000, water as the blowing agent and an amine catalyst. A chain extender can also be included in the polyol component to increase crosslinking density and the resulting strength of the microcellular foam. The polyether polyols may have an average number of functional groups of from 2 to 4 and a number average molecular weight ranging from 1000 to 10,000 or from 2000 and 8000. The greater the number of functional groups, the harder the resulting polyurethane. On the other hand, when the number average molecular weight of the polyether polyol exceeds 8000, the elastomeric polyurethane may begin to become less elastic.

Suitable polyether polyols for use in the two-component foam forming mixture are those known in the art. Included are, for example, the polyether polyols obtained by addition polymerizing an oxyalkylene compound of 2 to 4 carbon atoms, such as ethylene oxide or propylene oxide, to the lower aliphatic polyhydric alcohols of 2 to 6 carbon atoms such as glycerol and trimethylolpropane or to a low molecular weight active hydrogen compound containing at least two active hydrogen atoms such as ethylene diamine.

Further, for obtaining a microcellular polyurethane elastomer having good vibration isolation or damping properties a chain extender may be used as part of the polyol component. Suitable chain extenders may include diols and diamines, examples of which are ethylene glycol, propylene glycol, propanediol, butanediol, ethylenediamine and triethanolamine, of which preferred are the straight chain alkylene diols, particularly ethylene glycol or 1,4-butanediol.

Suitable polyisocyanates may include any known for use in making urethane elastomers. Examples are such polyisocyanates as 4,4′-diphenylmethanediisocyanate (MDI), naphthylenediisocyanate (NDI), tolylenediisocyanate (TDI) and hexamethylenediisocyanate (HMDI). These can also be used as mixtures of two or more thereof. Of these polyisocyanates, preferred are the aromatic diisocyanates such as MDI, NDI and TDI, particularly preferred being MDI. A polyisocyanate can also be used as a prepolymer condensed in advance with a chain extender. In either case, the organic polyisocyanate is advantageously used in an amount, expressed as the NCO index, of 90-110, preferably 95-105.

Water can be used as the blowing agent in producing a microcellular polyurethane elastomer in accordance with the present invention. While the amount of the blowing agent required for obtaining the polyurethane elastomer having a bulk density of ASTM D3676) of from 600 to 2000 Kg/m³ (0.6 to 2.0 g/cm³), or, preferably, from 700 to 1800 Kg/m³ (0.7 to 1.8 g/cm³) as intended by the present invention can be readily determined by those skilled in the art, the amount of blowing agent may range from 0.2 to 15 phr water, or, preferably, from 0.5 to 1 phr.

As a catalyst in the two-component foam forming mixture in accordance with the present invention, known tertiary amine compounds can be used. Examples may include triethyleneamine, diazabicycloundecene, n-methylmorphine, and N,N-dimethyl ethanolamine. The amount of catalyst used can be varied over a wide range in accordance with the reaction speed desired.

The two-component foam forming mixture in accordance with the present invention may further comprise organic reinforcing fibers, such a polyamide, polyaramide and polyacrylonitrile fibers.

In accordance with the multi-layer article of the present invention, the multi-layer article is suitable for use as a rail tie. The elongate rigid body that defines the railroad-ties of the present application may comprise concrete, fiber reinforced cement, or wood and is preferably a porous material. The elongate rigid body can be of any size and shape or material known in the art. For example, the ties may be configured to have a rectangular shape and a relatively uniform exterior surface; or, for example, the two locations where the track is to be seated (“trackseat areas”) onto the tie, the exterior surface is not flush with, and is either raised above or seated below, the remaining exterior surface area of the tie.

The multi-layer article may further comprise a polyurea or polyurethane urea layer between the substantially planar surface and the microcellular foam elastomeric pad to aid in making the elastomeric pad pucture resistant.

In another aspect in accordance with the present invention, molding methods comprise inflating an annular pneumatic seal, such as a rubber seal, contained in a molding device equipped with a structure that forms a top boundary of a molding chamber and an injection port extending into the molding chamber, wherein the annular pneumatic seal has an inner side and, adjacent the inner side, a top side and a bottom side. Inflating the annular pneumatic seal forms a circumferential side wall or side boundary of the molding chamber. Thus, positioning the molding device so that the bottom side of the annular pneumatic seal abuts against a substantially planar surface of an elongate rigid body, preferably, a porous surface, at an outer periphery of the substantially planar surface, thereby forming the bottom boundary of the molding chamber. Then, injecting, mixing and curing or injection molding a two-component foam forming mixture, preferably, a substantially organic solvent free two-component foam forming mixture, in the molding chamber forms an elastomeric pad directly on the substantially planar surface of the elongate rigid body.

In accordance with the molding device, the substantially planar surface of the elongate rigid body has a shape, length and a width so as to form a sealed underside or bottom boundary of the molding chamber, further wherein, the shape, length and width of each of the substantially planar surface and of the top boundary of the molding chamber are congruent or are the same. At least 50%, or, preferably, more than 50%, such as more than 55% or, preferably from more than 50 to 90% of the width of the bottom side of the annular pneumatic seal forms the annular seal with the substantially planar surface at its outer periphery. The area sealed by the bottom side of the annular pneumatic seal against the substantially planar surface forms a peripheral landing on the substantially planar surface of the elongate rigid body.

The top boundary of the molding chamber of the molding device of the present invention can comprise a mold plate having a shape, length and width so as to form a sealed top boundary of a molding chamber, the side boundary of which is formed by the annular pneumatic seal, and the bottom boundary of which abuts against a substantially planar surface of an elongate rigid body at an outer periphery of the substantially planar surface to form a seal and compete the molding chamber.

In the methods in accordance with the present invention, molding comprises keeping the two-component foam forming mixture and the substantially planar surface under pressure during molding. The pressure developed in the mold by inflating the annular pneumatic seal and by the weight of the molding device on the molding chamber may force more foam into the pores of the substantially planar surface of the elongate rigid body. This may also create more contact surface area between the foam and substantially planar surface of the elongate rigid body. Still further, the methods may comprise clamping the molding device to the elongate rigid body, thereby helping to kee the two-component foam forming mixture under pressure during molding.

Injecting and mixing the two-component foam forming mixture may comprise introducing each component of the foam forming mixture into a static mixer located in an injection port of the molding device. Alternatively, the method comprises pre-mixing the two-component foam forming mixture by high pressure, or dynamic mixing, such as with a mixing blade, and injecting the mixture into the molding chamber.

Preferably, in accordance with the methods of the present invention, the two-component foam forming mixture is a substantially solvent free polyurethane forming mixture of a polyol component and an isocyanate component, further comprising water as a blowing agent.

In accordance with the molding methods of the present invention, the top side of the molding chamber of the molding device comprises a mold plate and the method further comprises heating the top surface of the mold plate before injection molding. In the molding device in accordance with the present invention, the having an outer periphery that abuts against the annular pneumatic seal on its top side to form a seal and form the top and side boundary of the molding chamber of the molding device.

In accordance with the the present invention, the methods further comprise venting the molding chamber during molding. Little ports or holes in the molding chamber can allow air and other gases to escape.

In accordance with of the present invention, the methods may further comprise pre-coating the molding chamber of the molding device with a polyurea or polyurethane urea coating after inflating the annular pneumatic seal. The coating may be sprayed into the molding chamber of the molding device.

Preferably, multiple elongate rigid bodies are laid proximate to one another so that the methods can more than one pad at a time.

In yet another aspect of the present invention, a molding device comprises a molding chamber for forming a foam elastomeric pad, preferably, a closed cell or microcellular foam elastomeric pad. The molding chamber is defined at its side boundary by an annular pneumatic seal, on its top boundary by a mold plate, which is optionally heated, and, on its lower side by the substantially planar surface of the elongate rigid body. In use, the molding device may sit on top of the underside of a rail tie whereby the underside of the rail tie defines a bottom boundary of the molding chamber of the molding device. The molding device further comprises an injection port for introducing a moldable materials, for example, a two-component foam forming mixture into the molding chamber, and a frame assembly for attachment of at least the mold plate, the annular pneumatic seal and the injection port.

In accordance with the molding device of the present invention, the annular pneumatic seal insulates the molding chamber and a rail tie surface or the substantially planar surface from material leakage. To insure that the substantially planar surface surface and the annular pneumatic seal connect in an effective sealing manner, the contact width of the contacting portion of the annular pneumatic seal and the substantially planar surface of the elongate rigid body exceeds one half of the width of the annular pneumatic seal surface that contacts the substantially planar surface or, preferably, exceeds 55% of the width of the annular pneumatic seal surface that contacts the substantially planar surface. Thus, if an annular pneumatic seal is 2.56 cm wide at its base or lower side, the contact width between the annular pneumatic seal and the tie is at least 1.28 cm, or, preferably, at least 1.41 cm.

To form a sealed molding chamber, the shape, length and width of the mold plate of the molding device in accordance with the present invention matches the shape, length and width of the substantially planar surface of the elongate rigid body, so that they are congruent and form a molding chamber together with the annular pneumatic seal. The annular pneumatic seal comprises an inflatable material, such as rubber, having each of an inflatable lower, upper and inner side surface so that when it is inflated it forms an annular seal on its lower surface with an outer periphery of the substantially planar surface of the elongate rigid body to form the bottom boundary of the molding chamber and on its upper surface with an outer periphery of the mold plate to form the top boundary of the molding chamber. The annular seal has the shape of the outer edge of the substantially planar surface, for example, rectangular, and is positioned so that when the annular pneumatic seal is inflated the annular seal extends from the substantially planar surface of the elongate rigid body to the mold plate. At least 50%, or, preferably, more than 50%, such as more than 55% or, preferably from more than 50 to 90% of the width of the bottom side of the annular pneumatic seal forms an annular seal with the substantially planar surface at its outer periphery. When inflated, the outside portion of the annular pneumatic seal which does not seal on its bottom side against the substantially planar surface will not expand freely thus insuring adequate sealing pressure.

The molding chamber of the molding device is adapted to receive a moldable material, such as a two-component foam forming mixture.

In accordance with the present invention, the molding device comprises a frame assembly to accept and arrange its respective parts. The top plate is attached to or held in place by the frame assembly into which the heater pad or element and mold plate, and an insulator pad, if any, are attached. Both the mold plate and any heating pad and any insulator pad may be held in place in a slot formed by the underside of a top plate and the frame assembly; or, the mold plate, heating pad or element and any insulator pad are attached to the top plate, which is itself attached to the frame assembly. Also attached to the frame assembly, one or more lift handles for lifting or lowering the molding device. The frame assembly of the molding device may comprise lateral structural members into which the annular pneumatic seal and top plate each seat or connect. Accordingly, such structural members may extend along the entire length of the molding device and at its ends. Still further, the molding device may comprise a master plate held in the frame assembly and having a length and width that enable attachment and positioning of all handles, guide pins and plates, and, further, that accommodates the injection port. The molding device may still further comprise guide pins adapted to position the mold so that the mold plate rests on top of and congruent with the substantially planar surface. Still further, frame assembly of the molding device of the present invention, may include endplates to insure that all lateral structural members, plates and the annular pneumatic seal are held in a statically determinant arrangement.

In accordance with the present invention, the molding device may enable heating of the molding chamber to speed curing of the foaming reaction mixture. Heating can be effected using a heated pad to heat the whole inner surface of the molding chamber, for example, up to 80° C. The heated pad or heater element may be embedded between the mold plate, a top molding surface of the molding chamber, and an insulator board. Thus, the mold plate of the molding device in accordance with the present invention may have the heating pad or layer on its upper side. Both the mold plate and any heating device are held in place by a top plate. The top plate is congruent with the mold plate and extends beyond the entire width and length of the mold plate at least as far as the outer periphery of the substantially planar surface, thereby encompassing the length and width of the annular seal formed by the annular pneumatic seal.

The molding device may comprise one or more injection ports for filling the molding chamber of the molding device with the reaction mixture. Because of the length of the elongate rigid body or rail tie, the injection ports may be arranged periodically, for example, evenly along the molding device to address lengthwise sections of the substantially planar surface of the elongate rigid body to insure even and through simultaneous filing of the molding chamber.

To enhance adhesion of the elastomeric pad to the rail tie via molding, the molding device may include a mechanical fixture to clamp the molding device to the elongate rigid body and apply pressure along the seal between the annular pneumatic seal and the outer periphery of the substantially planar surface of the elongate rigid body.

Preferably, one or more vents or small air holes located in the mold plate of the molding device allow the gas produced during foaming to escape from the molding chamber of the mold. The vents may be arranged along the length of the molding device at periodic intervals. The vents may take the form of holes or indentations in the mold plate.

The molding device of the present invention and any plate, structural or frame member or connector thereof can be constructed one comprising metal, a rigid plastic or other material suitable for forming a molding chamber. Further, all plates and structural members may be connected using screws, rivets or other connectors; and, further, grooves may be employed where any member or plate may be disposed between two other statically determinant or fixed members or plates so as to create a pressure fit arrangement or a tongue and groove structure.

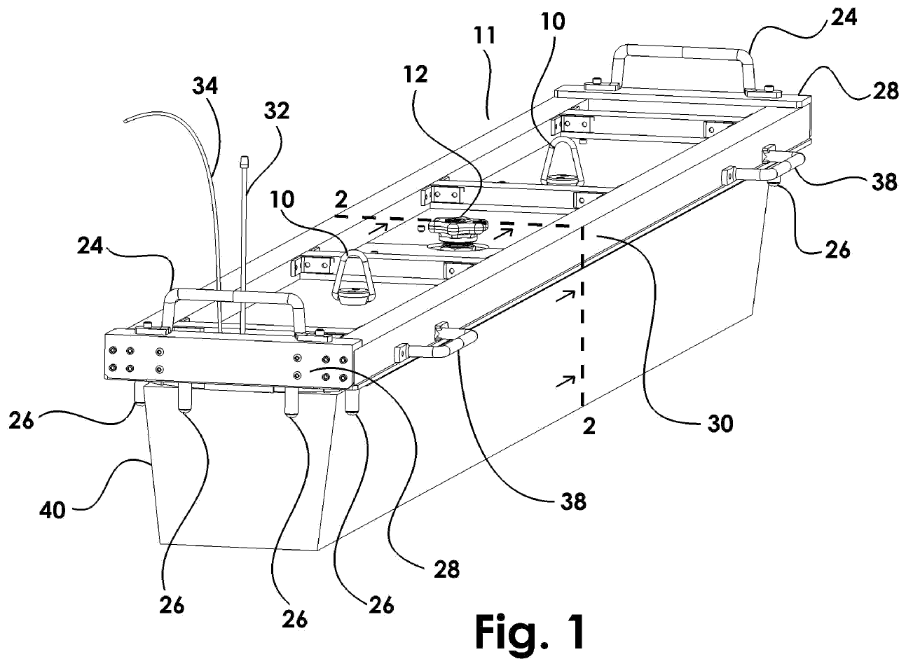

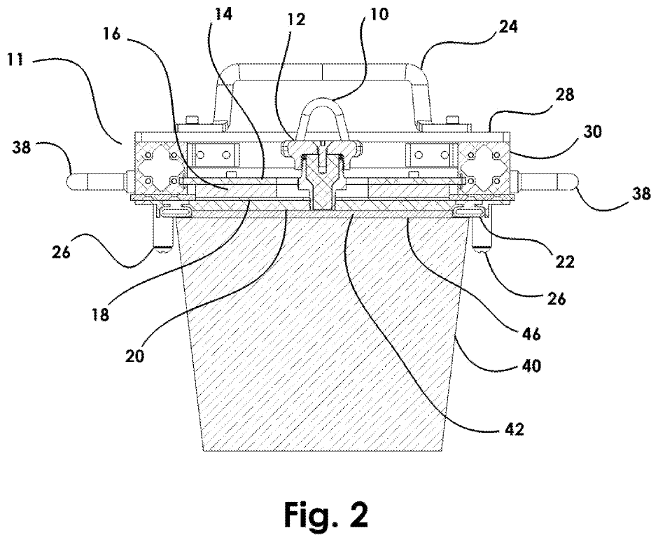

The molding device in accordance with the present invention can take many forms, including a manually operated version shown in FIGS. 1 and 2. In production, for example, the molding device may comprise a press with no handles, guide pins, lift rings, anything for manual handling or positioning.

As shown in FIG. 1, molding device (11) sits on top of elongate rigid body (40) in an exterior view of the apparatus and substrate. In operation, two lead lines provide, respectively, a pneumatic air supply (32) coming from a pressure regulator (not shown) feeding the annular pneumatic seal (22, FIG. 2), and an electrical supply line (34) and thermocouple wire (not shown) coming from a controller (not shown) to heated pad (18, FIG. 2). One or more lift handles (24) and lift rings (10) enable lifting or removing the molding device from elongate rigid body (40) when molding is complete. Further, side handles (38) enable one to generate more lifting force if needed to separate the molded elastomeric pad (42, FIG. 2) from molding device (11) after molding. Molding device (11) as shown further comprises multiple guide pins (26) adapted to position the device so that the mold plate (20, FIG. 2) rests on top of and congruent with the substantially planar surface (46, FIG. 2) of elongate rigid body (40). A frame assembly (30) comprising structural frame members extending the length of molding device (11) along either side. Frame assembly (30) further comprises an L bracket (28) endpiece of the frame assembly (30) extending across the two ends of molding device (11), thereby providing a static structure into which all elements of molding device (11) attach or fit. Frame assembly (30) still further accommodates attachment of guide pins (26) to aid in positioning molding device (11) congruence with one side of the elongate rigid body (40). The device shown includes only one injection port (12) for the two-component foam forming mixture, although it may comprise multiple injection ports spaced at intervals along the top of the molding device.

As shown in FIG. 2, molding device (11) defines the top and side boundaries of a molding chamber, respectively, as a mold plate (20) and an annular pneumatic seal (22) disposed around the periphery of the molding chamber. Elongate rigid body (40) forms the bottom boundary of the molding chamber. The molding chamber, shown as filled, forms the shape of elastomeric pad (42) that results after the two-component foam forming mixture is cured. Molding device (11) further comprises an injection port (12) and a frame (30) for attachment of all plates, layers, the annular pneumatic seal (22) and all other elements of molding device (11). A lift ring (10) facilitates manual removal of molding device from the elastomeric pad (42) when molding is complete. The molding device rests on top of the elongate rigid body (40) or rail tie so that a substantially planar surface (46) on the elongate rigid body (40) defines the bottom boundary of the molding chamber. In molding device, the substantially planar surface (46) and the mold plate (20) are congruent, having the same shape and extending for the same length and width so that they fit precisely on top of one another. The mold plate (20) is heated, for example, by use of a heated pad (18) positioned above and sized to be coextensive in length and width with mold plate (20). An insulator board (16) protects the outside of the molding device (11) from heated pad (18). To enable static connection of mold plate (20) within molding device (11), a top plate (14) provides attachment or a pressure fit for heated pad (18) and mold plate (20). A frame assembly (30) of two structural members runs along the entire length of molding device (11), with one on each side, and provides a seat into which top plate (14) and annular pneumatic seal (22) connect. One or more lift handles (24) and one or more side handles (38) enable the lifting or removing of molding device (11) from elongate rigid body (40) when molding is complete.

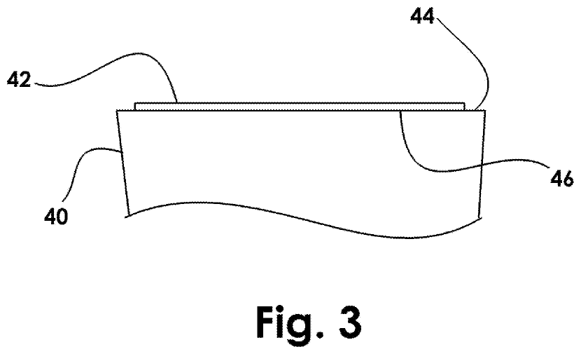

As shown in FIG. 3, a multi-layer article in accordance with the present invention comprises the elongate rigid body (40) having a microcellular foam elastomeric pad (42) formed directly on its substantially planar surface (46). Further, the multi-layer article provides a peripheral landing (44) on the substantially planar surface (46) which does not bear an elastomeric pad. Not shown, the microcellular foam elastomeric pad in accordance with the present invention has a densified outer skin and a less dense core.

The elastomeric pad in accordance with the present invention resists tearing and abrasion and comprises a microcellular foam elastomeric pad that has an outer layer or skin and a core, for example, wherein the average diameter or largest dimension of cells within the skin layer is at least no larger, or, preferably, is at least 5% smaller than the average diameter or largest dimension of the cells in the core. Such an elastomeric pad provides enhanced durability when the elastomeric pad is used as a foot for a rail tie.

Further, in accordance with the methods of the present invention, the elastomeric pad exhibits improved adhesion to the rail tie as the elastomeric pad is molded directly to the surface of the tie when both the surface of the rail tie and the two-component foam forming mixture that forms the pad are under pressure. For example, the methods may comprise molding wherein the rail tie has one or more through holes and comprises no plugs for at least one of the one or more through holes.

### EXAMPLES

The following examples illustrate the present invention. Unless otherwise indicated, all parts and percentages are by weight and all temperatures are in ° C. Unless otherwise indicated, all temperatures are room temperature and all pressures are standard pressure. The following abbreviations were used in the Examples that follow:

EO: Ethylene oxide; MDI: Methylene di(phenylisocyanate); RH: Relative Humidity.

### Examples 1 and 2 and Comparative Example 3

A dried cement rail tie (elongate rigid body) approximately 2.59 m (8.5 feet) long was placed into a support frame, bottom-side up. In Example 1, no precoat was applied prior to molding. In Example 2, in a molding device as shown in FIGS. 1 and 2, having a series of four injection ports evenly spaced along the elongate rigid body a polyurea coating composition shown in Table 1B, below, was sprayed onto the molding chamber surface wherein the heated pad was set at 80° C. and allowed to dry. In each of Examples 1 and 2, The molding device was clamped onto the tie using clamps attached to the tie support. In each of the Examples 1 and 2 and in Comparative Example 3, an annular pneumatic seal was pressurized to 34.47 to 103.41 kPa (5 to 15 psi) and, a two-component foam forming mixture, as shown in Table 1A, below, was injected as two separate components via a mix head nozzle through the injection port and was allowed to fill the molding chamber of the molding device. The mix head nozzle was removed from the injection port and the port was plugged. The two-component foam forming mixture was left to cure for from 5 to 10 minutes at 80° C. Then, molding device was unclamped and removed and the rail tie with pad was then removed from the tie support.

TABLE 1A
Two-Component Foam Forming Mixture

| | parts by | |
|---|---|---|
| | weight | Description |
| Polyol component | | |
| Polyether polyol 1 | 57.5 | EO-capped polyol of sucrose and |
| | | glucose mixture with average |
| | | functionality of 4.2, 7600 MW |
| Polyether polyol 2 | 11.0 | EO-capped diol made from ethylene |
| | | oxide and a diol, 2000 MW |
| Copolymer | 20.0 | Copolymer polyether polyol |
| polyether polyol | | |
| Branched Polyol | 2.5 | Ethylene oxide and propylene |
| (cell opening) | | oxide triol 5000 MW |
| 1,4-Butanediol, | 9.0 | Chain extender |
| Water | 0.2 | Blowing agent |
| DABCO ™, ¹ 1028, | 0.5 | Delayed action tertiary amine |
| gel catalyst | | gelling catalyst, |
| | | triethylenediamine in butanediol |
| DABCO ™, ¹ BL-17, | 0.1 | Delayed action tertiary amine |
| blow catalyst | | blowing catalyst, bis(2- |
| | | Dimethylaminoethyl) in dipropylene |
| | | glycol |
| DC-193², silicone | 0.2 | Silicone polyether surfactant |
| surfactant | | |
| Isocyanate component | | |
| HYPERLAST ™, ³ | 65.0 | 18.5% NCO MDI prepolymer from |
| LP 5600 isocyanate | | carbodiimide of MDI and a |
| | | 2000 MW polyether diol |

¹ Evonik industries Ag, Essen, DE;
²Dow Corning, Midland, MI;
³ Dow, Midland, MI.

TABLE 1B
Polyurea Coating Composition

| | parts by | |
|---|---|---|
| | weight | Description |
| Polyol component | | |
| JEFFAMINE ™ D-2000, | 79 | Polyether diamine, 2000 MW |
| polyether diamine | | (Huntsman Corp., Dallas, TX) |
| ETHACURE ™ 100, | 19 | Diethyltoluene diamine, chain |
| chain extender | | extender (Albemarle, Cary, NC) |
| Plasticolors DL-02830, | 2 | carbon black dispersion |
| black pigment | | (Chromaflo, Ashtabula, OH) |
| Isocyanate component | | |
| HYPERLAST ™ LP | 1:1 v/v | 12% NCO MDI prepolymer from |
| 5612 isocyanate | | MDI and 2000 MW polyether |
| | | polyol (fn = 2, Dow) |

### Results of Examples 1 and 2 and Comparative Example 3

The microcellular foam elastomeric pad in inventive Examples 1 and 2 exhibited a pull-off adhesion from the rail tie of (ASTM D7234) of 1.08 (157) MPa (lb/in²). By comparison, in Comparative Example 3, a pad made from the same two-component foam forming mixture on a rail tie having a recently poured or “green” concrete, which is solidified but dried for 3 h at 20% RH to form a partially cured concrete surface exhibited a pull-off adhesion of only 0.90 (130) MPa (lb/in²). The inventive microcellular foam elastomeric pad in Examples 1 and 2 exhibits a fairly high bulk density (ASTM D3676) of 740 (46.2) kg/m³ (lb/ft³). Finally, the inventive microcellular foam elastomeric pad exhibits a tear strength (ASTM D624 Die C), in Example 1 of 6.19 (35.4) kN/m (lb/in) and, in Example 2 of 9.01 (51.5) kN/m (lb/in). So, while the polyurea topcoat adds in tear strength, the microcellular foam elastomeric pad of the present invention exhibits good adhesion to a rail tie, a high density and good tear strength.

1. A multi-layer article for use as a rail tie comprising:
an elongate rigid body having a substantially planar surface and a microcellular foam elastomeric pad on the substantially planar surface comprising a microcellular foam of a polyurethane, wherein the substantially planar surface has a peripheral landing on which there is no elastomeric pad and the elastomeric pad has a bulk density (ASTM D3676) of from 600 to 2000 Kg/M³ (0.6 to 2.0 g/cm³).

2. The multi-layer article as claimed in claim 1, wherein the microcellular foam polyurethane is a foam comprising cells formed from water as a blowing agent.

3. The multi-layer article as claimed in claim 1, wherein the microcellular foam elastomeric pad has a core and an outer periphery having a skin around its outer periphery characterized by having a greater density in its skin than in its core.

4. The multi-layer article as claimed in claim 1, wherein the elongate rigid body comprises a porous material and the microcellular foam extends into the pores of the elongate rigid body.

5. The multi-layer article as claimed in claim 1 comprising:
an elongate rigid body having a length and a width, and a substantially planar surface extending the entire length and width of the elongate rigid body and adapted for use as a foot on which the elongate rigid body rests; and,
an elastomeric pad on the substantially planar surface comprising a microcellular polyurethane foam,
wherein, in the multi-layer article, the substantially planar surface has a peripheral landing on which there is no elastomeric pad.

6. The multi-layer article as claimed in claim 1, further comprising a polyurea or polyurethane urea layer between the substantially planar surface of the elongate rigid body and the microcellular foam elastomeric pad.

7. A method for making a multi-layer article comprising: inflating an annular pneumatic seal contained in a molding device and having an inner side and, adjacent the inner side, a top side and a bottom side with a width, the molding device equipped with a molding chamber having an upper structure that forms a top boundary of the molding chamber and abuts against the top side of the annular pneumatic seal to form the side boundary of the molding chamber, and equipped with an injection port extending through the upper structure into the molding chamber, thereby forming a circumferential annular seal against the top boundary of the molding chamber;
positioning the molding device so that the bottom side of the annular pneumatic seal abuts sealingly against a substantially planar surface of an elongate rigid body, at an outer periphery of the substantially planar surface, and,
molding by mixing and then injecting a two-component foam forming mixture into the molding chamber and curing it to form an elastomeric pad directly on the substantially planar surface of the elongate rigid body.

8. The method as claimed in claim 7, wherein the substantially planar surface has a shape, length and a width and, further wherein, the shape, length and width of each of the substantially planar surface and of the top boundary of the molding chamber are congruent or are the same.

9. The method as claimed in claim 7, wherein at least 50% of the width of the bottom side of the annular pneumatic seal forms an annular seal with the substantially planar surface at its outer periphery.

10. The method as claimed in claim 9, wherein more than 55% of the width of the bottom side of the annular pneumatic seal forms a seal with the substantially planar surface at its outer periphery.

11. The method as claimed in claim 7, wherein molding comprises keeping the two-component foam forming mixture and the substantially planar surface of the elongate rigid body under pressure during molding.
